(19) United States
(12) Patent Application Publication
(10) Pub. No.: US 2025/0139497 A1
(43) Pub. Date: May 1, 2025

(54) AUTOMATED BEST-EFFORT MACHINE LEARNING COMPRESSION AS-A-SERVICE FRAMEWORK

(71) Applicant: Dell Products L.P., Round Rock, TX (US)

(72) Inventors: Victor da Cruz Ferreira, Rio de Janeiro (BR); Thais Luca Marques de Almeida, São Gonçalo (BR); Claudio Romero, Rio de Janeiro (BR); Paulo Abelha Ferreira, Rio de Janeiro (BR); Alexander Eulalio Robles Robles, Valinhos (BR)

(21) Appl. No.: 18/495,986

(22) Filed: Oct. 27, 2023

(51) Int. Cl. G06N 20/00

(52) U.S. Cl. CPC G06N 20/00

(57) ABSTRACT

Generating and ranking compressed models is disclosed. A model file is received as input and filtered against a catalog of compression algorithms. Compressed models are generated from the compression algorithms identified from the catalog. Hyperparameters for the compression algorithms may be determined by searching past executions. The compressed models are evaluated based on one or more metrics. The compressed models are ranked and may be selected for use.

### FIELD OF THE INVENTION

Embodiments of the present invention generally relate to compressing machine learning models. More particularly, at least some embodiments of the invention relate to systems, hardware, software, computer-readable media, and methods for a framework or system configured to provide machine learning model compression as a service.

### BACKGROUND

Machine learning models are becoming ubiquitous and provide significant advantages. At the same time, machine learning models present some practical problems. For example, the size of a machine learning model can impact performance and resource requirements. These issues, for example, can hinder model deployment and model adoption. To address these and other challenges, techniques have been developed to compress machine learning models while maintaining similar quality metrics (e.g., accuracy).

Standard model compression techniques include quantization and pruning. These techniques, however, require a developer to perform parameter fine-tuning while changing the development cycle to incorporate different techniques. In fact, finding the best technique or combination of techniques for compressing machine learning models is not trivial. Extensive expertise and analysis is required before deploying compressed models.

More specifically, tuning model parameters in the context of model compression is difficult. Incorporating compression techniques into the development cycle may create a bottleneck because the peculiarities of each technique must be addressed. These issues also complicate the task of searching for the best compressed model.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a method for generating and/or selecting a compressed model;

FIG. 2 discloses aspects of a framework for compressing machine learning models;

FIG. 3 discloses additional aspects of a framework for compressing machine learning models;

FIG. 4 discloses aspects of an example of compression as-a-service; and

FIG. 5 discloses aspects of a computing device, system, or entity.

### DETAILED DESCRIPTION OF SOME EXAMPLE EMBODIMENTS

Embodiments of the present invention generally relate to machine learning models and to compressing machine learning models. More particularly, at least some embodiments of the invention relate to systems, hardware, software, computer-readable media, and methods for automating the process of compressing machine learning models and selecting a compressed machine learning model.

Embodiments of the invention relate to a framework or system for automating machine learning model compression. The framework or system abstracts and removes various requirements from the user. For example, embodiments of the invention automate the process of selecting a compression technique or algorithm and the process of setting up or configuring compression parameters. Embodiments of the invention may select or identify compressed machine learning models in a best-effort manner.

In one example, a system for compressing machine learning models or a machine learning model compression as-a-Service (aaS) allows users to submit a model and receive, in return, a compressed model. The need for users to set compression hyperparameters and manually search for the best compression algorithms is removed.

More specifically, the input to the framework or system includes a machine learning model (e.g., a model file). The input may also include other information or data such as the intended task, datasets to be considered by the model, execution platform/capability (e.g., CPU, GPU, Accelerator), or the like. The model file can be generated with any standard machine learning framework such as PyTorch, TensorFlow or ONNX.

Once the input is received, a mutable compression catalog (MCC) is filtered according to the inputs. The MCC contains a set of available compression techniques or algorithms available or implemented in the model compression framework. The MCC may also be filtered according to the input values to speed up the compression process. The filtering process is therefore based on several factors such as the model file input and other constraints.

Next, a set of compressed models are generated using the compression algorithms identified by filtering the MCC using the input. In some examples, compression algorithms may be viewed or implemented as services or microservices and new compression techniques can be added to the MCC as they become available.

The compression as a service framework may also include a performance analysis mechanism (PAM) that periodically evaluates how the current compression algorithms or techniques are performing and permanently removing them from the MCC as they become outdated. The PAM may be configured to maintain an up-to-date compression algorithm list and manage hyperparameter searches.

If the compression algorithm requires a hyperparameter search, the PAM may be used to perform a smart guided search. In one example, the smart search uses telemetry data saved from a database which stores the parameters from previous ‘best’ models produced by the framework. The procedure also uses a random factor which allows exploration of new parameter variations while still leveraging previously successful options. If previous data is not available, a grid or random search may be performed.

After generating one or more compressed models, the compressed models are evaluated. The evaluation may include comparing execution time, memory footprint, accuracy (or other quality metric), or the like. The outputs are ranked suggestions of models that performed better in each of the evaluation metrics. Information about the compressed models, their parameters and which model is ultimately selected are stored in a database for future inspection or use by the PAM.

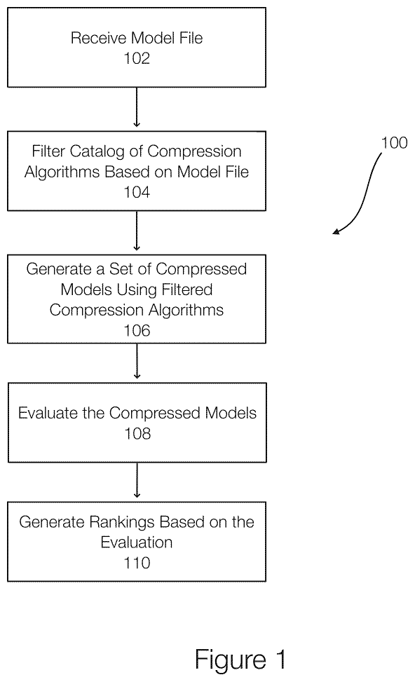

FIG. 1 generally discloses aspects of an example method for generating and/or selecting a compressed model. In the method 100, a model file 102 may be received. A customer, for example, may submit a model file to a model compression as a service framework and receive, in return a ranked list of compressed models or a specific compressed model that is selected from the ranked list automatically.

The model received by the framework is used to filter 104 a catalog. Filtering the catalog based on the received model allows compression algorithms to be identified. This aspect of the method 100 may identify the compression algorithms that are suitable for the model file based on the model file itself and/or other information that may have been received by the framework, such as intended task, execution environment, or the like.

Next, a set of compressed models are generated 106 using the filtered compression algorithms. In one example, each of the compression algorithms filtered or selected form the catalog are used to generate at least one compressed model from the original model file.

The compressed models are then evaluated 108 on various aspects such as execution time, memory footprint, accuracy (or other quality metric), or the like or combination thereof. The rankings are generated 110 based on the evaluation and the top or highest ranked compressed model may be returned in response to the request to compress a model file received by the compression framework.

The method 100 is an example of a best-effort search over multiple compression algorithms that are then ranked according to various metrics. When a new model file (e.g., a configuration-weights file) is received by the compression framework, embodiments of the invention are configured to return a compressed model without requiring any compression knowledge from the user. Embodiments of the invention perform a search over various compression algorithms, generate compressed models, and evaluate the compressed models according to different metrics. Embodiments of the invention also include components or modules (e.g., PAM and MCC) that are configured to improve the performance of a compression pipeline while updating a list of up to date compression algorithms.

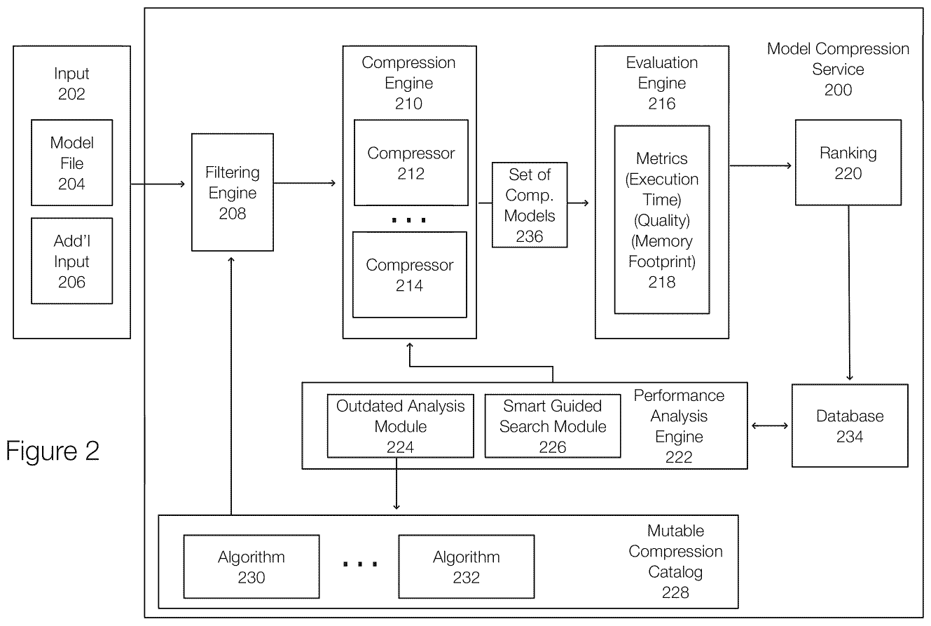

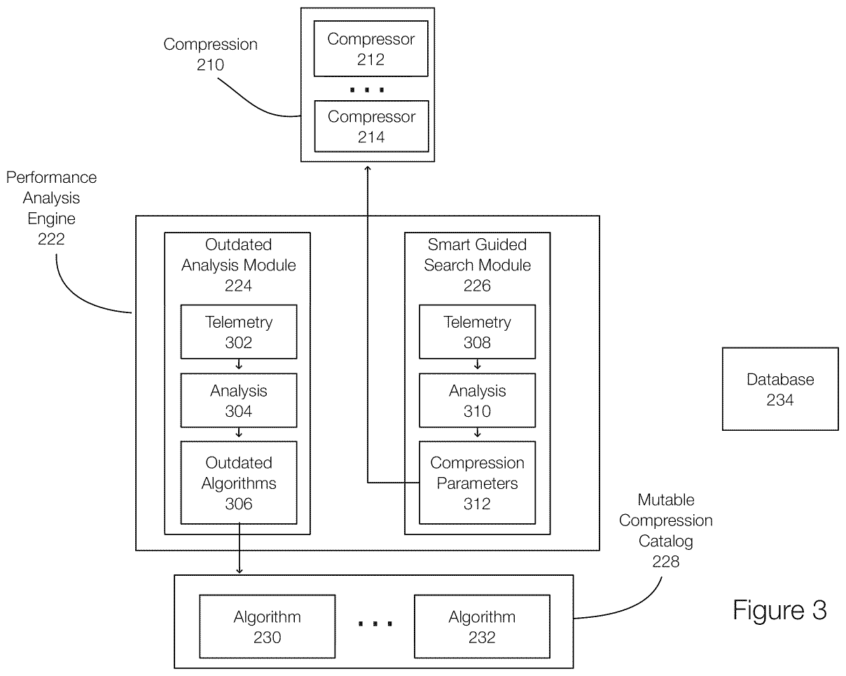

FIG. 2 discloses aspects of a model compression service for generating compressed models and for identifying or selecting compressed models in response to a user or customer request. FIG. 3 discloses additional aspects of performance analysis in the model compression service.

The framework illustrated in FIG. 2 is illustrated as a model compression service 200. The model compression service 200 may operate in a cloud environment and may be configured as-a-service, or a model compression as-a-service in one example. The model compression service 200 is configured to receive model files as input, generate compressed models, evaluate the compressed models, and rank the compressed models based on the evaluation. The highest ranked compressed model may be returned in response to the user request.

In FIG. 2, a user may submit a request that includes input 202. The input 202 received by the model compression service 200 may include a model file 202 and additional input 206. The additional input 206 is not necessarily required, buy may improve the results. The model file 202 should include enough information to enable loading a model and the model's weights into memory (thus, including the model as a whole in the model file 204 may not be required). If necessary, the model compression service 200 will convert the model file 204 to an appropriate framework as different compression algorithms may be written for different frameworks.

The additional input 206 may include information that may assist in searching for or finding compression algorithms to be applied and may ensure that the evaluation of the compressed models is more accurate. For example, the additional input 206 may identify a target environment or system in which the compressed model will execute, a dataset, which may be selected from pre-established benchmarks, or the like. Uploading the dataset may improve the rankings generated by the model compression service 200. The additional information may allow the process of searching for compression algorithms to be more focused (e.g., the search space may be reduced), thereby providing a boost in performance.

The model compression service 200 also includes a mutable compression catalog (MCC) 228. The MCC 228 includes the compression algorithms, represented by algorithms 230 and 232, that are available in the model compression service 200. The MCC 228 may also include metadata information describing the techniques, machine learning frameworks, and compression algorithms that are supported by the model compression service 200.

The MCC 228 is mutable such that algorithms be added, removed, and/or updated. In one example, a compression algorithm, such as the algorithm 230, may be deployed as a microservice. The MCC 228 can be updated as new compression techniques or libraries become available.

The performance analysis engine 222 includes an outdated analysis module 224 and a smart guided search module 226 and FIG. 3 discloses additional aspects regarding the performance analysis engine 222. The performance analysis engine 222 is configured to collect telemetry data from previous framework executions (i.e., executions of the model compression service). This allows the searching space to be reduced for subsequent executions. The telemetry data may include execution time and other metrics, hyperparameters and other configuration data.

For example, the performance analysis engine 222 may collect data from every compressed model from the model compression service 222. The performance analysis engine 222 is configured to store all information regarding which positions each compressed model achieved in the ranking process, the results for the various metrics, the compression algorithm used to compress the model, and which hyperparameters were used. The data collected by the performance analysis engine 222 can be stored in the database 234 or other storage and may be used, in one example, for statistical analysis.

The MCC 228 benefits from the performance analysis engine 222 at least because the performance analysis engine 222 can monitor the compression algorithms 230 and 232 to determine which are performing better and which are performing worse. If a particular compression algorithm, such as the algorithm 230 is frequently low ranked and rarely achieves good or satisfactory metrics, the performance analysis engine 222 may consider the algorithm 230 to be outdated/ineffective and may remove the algorithm 230 from the MCC 228.

Thus, the outdated analysis module 224 may collect or monitor telemetry data 302 related to the compression algorithms represented by the algorithms 230 and 232. The telemetry data 302 may include execution metrics, rankings, or the like. An analysis 304 on the telemetry data 302 may identify outdated or ineffective algorithms 306, which are then removed from the MCC 228. For example, consistently being ranked outside of the top five may result in removal from the MCC 228.

The performance analysis engine 222 may also include a smart guided search module 226. In one example, embodiments of the invention may perform a search for hyperparameters for the compression algorithms. When using compression algorithms, libraries may require fine-tuning parameters to find the best model compression. As a result, some of the compression algorithms in the MCC 228 may require the model compression service 200 to set hyperparameters.

The performance analysis engine 222 may use telemetry data 308 to perform a statistical analysis to discover which hyperparameters were used on previous high-ranked executions. This is an example of a smart guided search. To allow for the discovery of new parameters, a random exploration factor, which enables the evaluations of new variations, may be introduced. The analysis 310 of the previously used hyperparameters allows compression parameters 312 to be identified and used in configuring the compressors 212 and 214, which represent the compressors selected to compress the model file or model.

Returning to FIG. 2, after receiving the input 202, the model compressing service 200 may use a filtering engine 208 to filter the algorithms 230 and 232. The algorithms in the MCC 228 can be filtered based on information about the model such as model format. If the additional input 206 is provided, the algorithms in the MCC 228 can be filtered based on device information, execution environment (e.g., GPU-only), or the like. This reduces the search space. For example, for a model requiring a GPU environment, the filtering engine 208 may exclude compression algorithms that optimize for CPU execution from consideration.

Thus, the filtering engine 208 may identify compression algorithms are applicable for compressing the model file 204. The compression engine 210 may perform compression using various compressors, represented by the compressors 212 and 214. For example, the compressor 212 may be used to generate multiple compressed models, represented by M₁^{Alg1}, M₂^{Alg1}, . . . . The compressor 214 may generate multiple compressed models, represented by M₁^{Alg2}, M₂^{Alg2}, . . . . In this example, the superscript identifies the algorithm used to compress the input model and the subscript identifies different various of the compressed model generated using different hyperparameter variations. In one example, the smart guided search module 226 may be used to select or identify hyperparameters.

The output of the compression engine 210 is a set of compressed model, each resulting from a different algorithm and/or using different hyperparameters.

The evaluation engine 216 evaluates the set of compressed models 236 and generates a ranking 220, which may be stored in the database 234. The set of compressed models 236 may be evaluated in terms of execution time, quality, memory footprint or other metrics 216. For example, the rankings 220 may include a ranking for each metric individually, a ranking that reflects a combination of the metrics, or the like.

The metrics 218 generally refer to performance metrics that demonstrate how well the model is solving the current task. An example metric is accuracy. However, some problems may require different quality metrics. In one example, the dataset, which may be included in the additional input 206, may be used to generate a quality metric such as accuracy. If the sample dataset is provided as part of the input 202, the dataset can be run using the uncompressed model and the compressed versions of the model. This allows the compressed models to be ranked based on how the metric improves or deteriorates. If the user refers to a known benchmark, the model compression service can use the benchmark and follow the same procedure. Within the context of this invention, what defines how we derive the quality metric is the optional input dataset. If the user provides a sample dataset as input, we can run it over the input model and all the compressed versions to rank how the metric improves or deteriorates. In case the user refers a known benchmark, the framework can use said benchmark from the database and follow the same procedure.

However, if the dataset is not available, embodiments of the invention relate to indicating or determining how the accuracy is impacted. Because the model file 204 is available, the input and output layers can be probed to understand the input and output shapes. This information allows random data to be input to the model and allows the output or response. to be evaluated. After generating the set of compressed models 236, the model compression service 200 feeds the compressed models with the same random data and compares the outputs against the input model. The model compression service 200 may rank the compressed models by smaller deviation between results against the input model. Smaller deviations receive a higher ranking.

Measuring execution time when executing different models on different devices may cause discrepancies that may lead to an inconclusive result. In fact, the model compression service 200 may not have configurations on which the compressed model will run. In one example, embodiments of the invention may determine execution time using the same GPU or CPU. However, this may not be scalable and some compression strategies may require different devices for compatibility. For example, a Nvidia GPU may have a transformer engine with INT8 support, while another GPU only supports BF16. As a result, different compressed models will have very different execution times depending on the available devices.

To mitigate the error between measurements from different devices, a relative comparison may be used instead of absolute values in seconds. This can be achieved by always executing the input model on devices that will be used during the execution time measurements to create a baseline. For example, if during the evaluation, a compressed model executes in a Nvidia A100 and another compressed model in a H100, the model compression service 200 will also measure execution time from the input model on both GPUs. The model compression service 200 can then evaluate the speedup or slowdown of the compressed model against the input model baseline measurements from the same device. The speedup/slowdown values are the used, in one example, for execution time ranking. In one example, when measuring execution time, random data may be used as the input.

The memory footprint is measured by performing inferences on the model and probing the device memory. There is no need to have a dataset or benchmark, as random data based on the model input shape can be used. This metric may also be susceptible to the selected device.

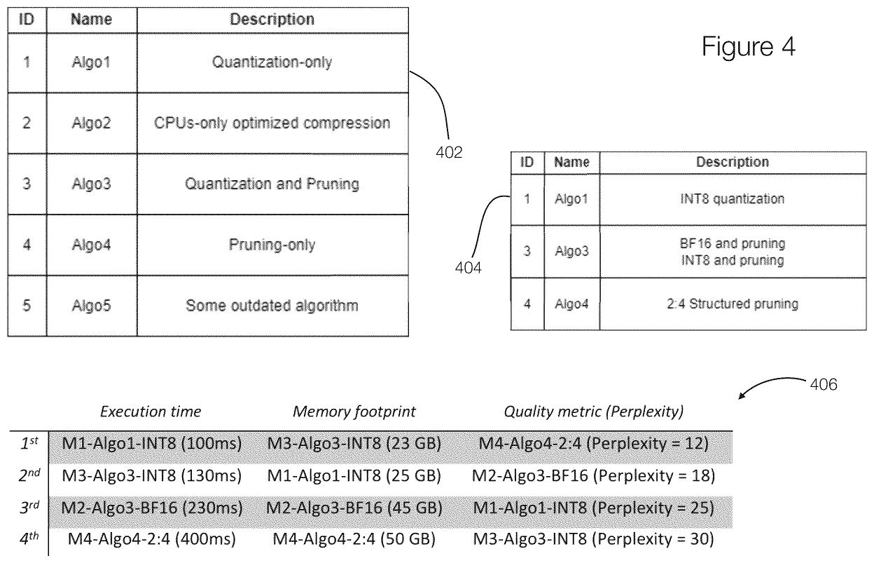

FIG. 4 discloses aspects of an example of compression as-a-service. Consider a scenario where it is desirable execute a large language model (LLM1) in a GPU-only environment that is limited to 48 GB GPU VRAM. This is an example of the model file. Additional input includes a dataset of text samples that are relevant to an intended application.

Additionally, in this example, the model compression service includes characteristics as illustrated in the table 402. These algorithms may be included in the MCC. Further, the PAM has access to telemetry information for all of the algorithms in the MCC or in the table 402. The table 404 illustrates hyperparameters selected by the PAM for each algorithm.

With reference to FIG. 2, the input 202 in this example includes a model file 204 containing LLM1. The additional input 206 includes execution environment such as a GPU-only toggle/input, and a dataset of text samples.

The filtering engine 208 receives this input 202 and filters against the MCC 228 (or table 402. During filtering, Algo1, Algo3, and Algo4 are selected. Algo2 is filtered out since it is not applicable to GPU-only scenarios. Algo5 was removed from the MCC by PAM because it is outdated. In other words, the outdated analysis module 224 of the performance analysis engine 222 removed the Algo5 from the MCC 228.

The compression engine 210 executes all three compression algorithms selected from the MCC 228 using hyperparameters selected by the smart guided search module 226 of the performance analysis engine 222. For Algo1, only INT8 was selected because other quantization levels were poorly ranked in previous executions. For Algo4, only 2:4 structured pruning was selected because other pruning options were poorly ranked in previous executions. Finally, four compressed models in total are generated: M1-Algo1-INT8, M2-Algo3-BF16, M3-Algo3-INT8, and M4-Algo4-2:4.

The evaluation engine 216 then evaluates these four compressed models by measuring their execution times, memory footprint, and, in this example, perplexity with the provided dataset that was included in the input 202.

The ranking 220 is illustrated in the table 406 and illustrates how the four compressed models were ranked according to these metrics. In the results for the given scenario, the compressed model M4-Algo4-2:4 is ranked best in the quality metric (lowest Perplexity). However, this model uses more GPU memory than the user has available. In this case, the user would probably select model M2-Algo3-BF16 (the second best in the quality metric) or select M1-Algo1-INT8 if execution time was a significant concern.

Thus, the ranking 220 may give a user flexibility in terms of selecting a model that meets their specific circumstances.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, machine learning model relate operations, filtering operations, model compression operations, evaluation operations, ranking operations, and the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data storage functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), and storage disks, for example, may likewise take the form of software, physical machines, containers, or virtual machines (VMs), though no particular component implementation is required for any embodiment.

As used herein, the term ‘data’ is intended to be broad in scope. Example embodiments of the invention are applicable to any system capable of storing and handling various types of data or objects, in analog, digital, or other form.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving an input at a model compression service, wherein the input includes a model file and the model compression service is configured to generate compressed models, filtering a catalog of compression algorithms based on the input to identify a set of compression algorithms, generating a set of compressed models using the set of compression algorithms, evaluating each compressed model in the set of compressed models based on at least one metric, and ranking the set of compressed models.

Embodiment 2. The method of embodiment 1, wherein the input further includes at least one of an intended application, a dataset, and/or a target execution environment.

Embodiment 3. The method of embodiment 1 and/or 2, wherein filtering the catalog of compression algorithms includes comparing the input to each of the compression algorithms, wherein compression algorithms that are not suitable for the input are not included in the set of compression algorithms.

Embodiment 4. The method of embodiment 1, 2, and/or 3, further comprising performing an analysis on the compression algorithms in the catalog, wherein consistently low ranked compression algorithms are removed from the catalog.

Embodiment 5. The method of embodiment 1, 2, 3, and/or 4, further comprising performing a smart guided search based on telemetry data of previous executions to determine a set of hyperparameters to be applied to the compressed algorithms that generate the compressed models.

Embodiment 6. The method of embodiment 1, 2, 3, 4, and/or 5, further comprising generating at least one compressed model from each compression algorithm in the set of compression algorithms, wherein each compressed model for a particular compression algorithm is associated with different hyperparameters.

Embodiment 7. The method of embodiment 1, 2, 3, 4, 5, and/or 6, further comprising evaluating each of the compressed models based on at least one metric.

Embodiment 8. The method of embodiment 1, 2, 3, 4, 5, 6, and/or 7, wherein the at least one metric includes at least one of an execution time, accuracy, a quality metric, a memory footprint, perplexity and/or a metric correlated to execution of the compressed model.

Embodiment 9. The method of embodiment 1, 2, 3, 4, 5, 6, 7, and/or 8, further comprising ranking the compressed models in each of the at least one metric.

Embodiment 10. The method of embodiment 1, 2, 3, 4, 5, 6, 7, 8, and/or 9, further comprising presenting the rankings to a user, and delivering the compressed model selected by the user.

Embodiment 11 A non-transitory storage medium having stored therein instructions that are executable by one or more hardware processors to perform operations comprising the operations of any one or more of embodiments 1-10.

Embodiment 12. A system, comprising hardware and/or software, operable to perform any of the operations, methods, or processes, or any portion of any of these, disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, service, client, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

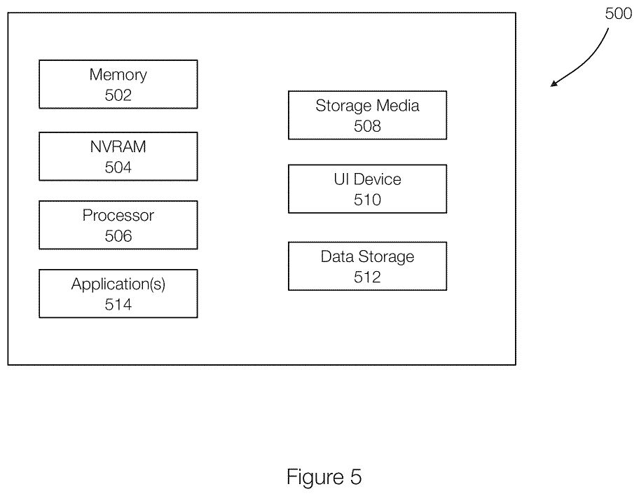

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein. The device 500 may also represent multiple devices (e.g., servers), or networks such as edge networks.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving an input at a model compression service, wherein the input includes a model file and the model compression service is configured to generate compressed models;
filtering a catalog of compression algorithms based on the input to identify a set of compression algorithms;
generating a set of compressed models using the set of compression algorithms;
evaluating each compressed model in the set of compressed models based on at least one metric; and
ranking the set of compressed models.

2. The method of claim 1, wherein the input further includes at least one of an intended application, a dataset, and/or a target execution environment.

3. The method of claim 1, wherein filtering the catalog of compression algorithms includes comparing the input to each of the compression algorithms, wherein compression algorithms that are not suitable for the input are not included in the set of compression algorithms.

4. The method of claim 1, further comprising performing an analysis on the compression algorithms in the catalog, wherein consistently low ranked compression algorithms are removed from the catalog.

5. The method of claim 1, further comprising performing a smart guided search based on telemetry data of previous executions to determine a set of hyperparameters to be applied to the compression algorithms that generate the compressed models.

6. The method of claim 5, further comprising generating at least one compressed model from each compression algorithm in the set of compression algorithms, wherein each compressed model for a particular compression algorithm is associated with different hyperparameters.

7. The method of claim 1, further comprising evaluating each of the compressed models based on at least one metric.

8. The method of claim 7, wherein the at least one metric includes at least one of an execution time, accuracy, a quality metric, a memory footprint, perplexity and/or a metric correlated to execution of the compressed model.

9. The method of claim 8, further comprising ranking the compressed models in each of the at least one metric.

10. The method of claim 9, further comprising presenting the rankings to a user, and delivering the compressed model selected by the user.

11. A non-transitory storage medium having stored therein instructions that are executable by one or more hardware processors to perform operations comprising:
receiving an input at a model compression service, wherein the input includes a model file and the model compression service is configured to generate compressed models;
filtering a catalog of compression algorithms based on the input to identify a set of compression algorithms;
generating a set of compressed models using the set of compression algorithms;
evaluating each compressed model in the set of compressed models based on at least one metric; and
ranking the set of compressed models.

12. The non-transitory storage medium of claim 11, wherein the input further includes at least one of an intended application, a dataset, and/or a target execution environment.

13. The non-transitory storage medium of claim 11, wherein filtering the catalog of compression algorithms includes comparing the input to each of the compression algorithms, wherein compression algorithms that are not suitable for the input are not included in the set of compression algorithms.

14. The non-transitory storage medium of claim 11, comprising performing an analysis on the compression algorithms in the catalog, wherein consistently low ranked compression algorithms are removed from the catalog.

15. The non-transitory storage medium of claim 11, further comprising performing a smart guided search based on telemetry data of previous executions to determine a set of hyperparameters to be applied to the compression algorithms that generate the compressed models.

16. The non-transitory storage medium of claim 15, further comprising generating at least one compressed model from each compression algorithm in the set of compression algorithms, wherein each compressed model for a particular compression algorithm is associated with different hyperparameters.

17. The non-transitory storage medium of claim 11, further comprising evaluating each of the compressed models based on at least one metric.

18. The non-transitory storage medium of claim 17, wherein the at least one metric includes at least one of an execution time, accuracy, a quality metric, a memory footprint, perplexity and/or a metric correlated to execution of the compressed model.

19. The non-transitory storage medium of claim 18, further comprising ranking the compressed models in each of the at least one metric.

20. The non-transitory storage medium of claim 19, further comprising presenting the rankings to a user, and delivering the compressed model selected by the user.
